(19) United States
(12) Patent Application Publication
(10) Pub. No.: US 2008/0255402 A1
(43) Pub. Date: Oct. 16, 2008

(54) SYSTEM FOR SEPARATING AND EXTRACTING HEAVY METALS FROM POLLUTED LIQUID WASTE

(76) Inventors: Chi-Wang Li, Danshuei Township (TW); Yi-Ming Chen, Tamsui (TW); Shin-Tien Hsiao, Tamsui (TW)

Correspondence Address: SCHMEISER, OLSEN & WATTS, 22 CENTURY HILL DRIVE, SUITE 302, LATHAM, NY, 12110, US

(21) Appl. No.: 11/735,018

(22) Filed: Apr. 13, 2007

(51) Int. Cl. A62D 3/33

(52) U.S. Cl. 588/412

(57) ABSTRACT

A system for separating and extracting heavy metals from polluted liquid waste includes a pressurizing unit for pressurizing an extracting solvent using a high-pressure gas, so that the extracting solvent contains supersaturated air and is then jetted into a pneumatic stirring, reacting and separating apparatus, in which the supersaturated air in the extracting solvent instantaneously leaches out to thereby produce a large quantity of micro-sized extracting solvent-bearing bubbles that react with heavy metal-polluted liquid waste contained in the pneumatic stirring, reacting and separating apparatus to separate heavy metals from water. A gas supplying device is connected to and supplies gas to the pneumatic stirring, reacting and separating apparatus to stir the heavy metal-polluted liquid waste. And, a pumping unit is connected to the pneumatic stirring, reacting and separating apparatus to pump out heavy metal-separated water to achieve the object of removing heavy metals from liquid waste.

### FIELD OF THE INVENTION

The present invention relates to a system for separating and extracting heavy metals from polluted liquid waste, and more particularly to a system in which a supersaturated air-containing extracting solvent is jetted into a pneumatic stirring, reacting and separating apparatus for reacting with heavy metal-polluted liquid waste stored therein to thereby separate the heavy metal from the polluted liquid waste.

### BACKGROUND OF THE INVENTION

With developments in industrial fields, various products can be conveniently and economically made through chemical processes. However, chemical industry also produces environmentally hazardous substances. Among others, heavy metals have become a serious pollutant to human environment. Once the hazardous heavy metals have flown into water, they would dangerously harm different ecologies and human health.

In one of the currently available processes for separating and extracting heavy metals from polluted liquid waste, a reaction system is provided to utilize a liquid membrane and associate it with extracting and stripping actions. In this technique, an extracting solvent is stored in pores of a porous membrane to produce a liquid membrane, which separates an input phase or waste water from a strip phase. With this liquid membrane, heavy metals are extracted from the heavy metal-containing input phase, and then concentrated and separated at the strip phase. According to the type of membrane being adopted, the liquid membrane process may be divided into a flat sheet supported liquid membrane (FSSLM) process and a hollow fiber supported liquid membrane (HFSLM) process. In the FSSLM process, the extracting and the stripping occurs only within a middle portion of the membrane, resulting in a very low ratio of workable surface area to volume. Therefore, the FSSLM process has very low heavy metal removal efficiency. To increase the ratio of workable surface area to volume, it has been tried to store the extracting solvent in hollow fibers on a membrane to increase the reaction surface area. This is referred to as the HFSLM process. However, the HFSLM process provides only very limited improvement in the heavy metal removal efficiency.

The above-mentioned processes of separating and extracting heavy metals from polluted liquid waste utilize a liquid membrane to separate the extracting from the stripping to complete the extracting and the stripping reaction at the same time in one procedure, and therefore have a very slow heavy metal removal rate. This is because a metal-chelate compound thereof is transmitted in the extracting solvent at a very slow speed. To overcome this problem, a so-called air-assisted extraction process is developed. In this process, air is caused to pass through a solvent phase or oil phase via a plurality of very small orifices, so as to jet out oil-coated air bubbles. The air bubbles move upward in the polluted liquid waste while extracting and removing heavy metals. In the air-assisted extraction process, only the extraction reaction occurs and fresh solvent is continuously supplied. Therefore, the influence of the heavy metal transmission speed in the extracting solvent on the heavy metal removal rate is relatively reduced to enable largely increased heavy metal removal rate. While the air-assisted extraction process has a quite high metal mole flux, the extraction rate of the air-assisted extraction process is restricted by the oil-coated air bubble production speed, i.e., restricted by the air flow. In the event a high-speed air flow is supplied, a large amount of solvent is pushed out without producing oil-coated air bubbles.

It is therefore desirable to develop a system for separating and extracting heavy metals from polluted liquid waste, so that heavy metal-polluted liquid waste may react with a large quantity of extracting solvent-bearing micro-sized air bubbles to allow quick separation of heavy metals from water to achieve the purpose of removing heavy metal pollution.

### SUMMARY OF THE INVENTION

A primary object of the present invention is to provide a system for separating and extracting heavy metals from polluted liquid waste, so that heavy metal-polluted liquid waste reacts with a large quantity of micro-sized extracting solvent-bearing air bubbles in a pneumatic stirring, reacting and separating apparatus to quickly separate heavy metal from water and thereby achieve the purpose of removing the heavy metal pollution.

To achieve the above and other objects, the system for separating and extracting heavy metals from polluted liquid waste according to a preferred embodiment of the present invention includes a pneumatic stirring, reacting and separating apparatus for containing an amount of heavy metal-polluted liquid waste therein; a gas supplying device connected to the pneumatic stirring, reacting and separating apparatus for supplying an amount of gas to stir the heavy metal-polluted liquid waste in the pneumatic stirring, reacting and separating apparatus; a pumping unit connected to the pneumatic stirring, reacting and separating apparatus for pumping out heavy metal-separated water obtained from the polluted liquid waste reacted in the pneumatic stirring, reacting and separating apparatus; and an extracting solvent pressurizing unit, in which an amount of extracting solvent is pressurized using a high-pressure gas to thereby contain supersaturated air, and then jetted into the pneumatic stirring, reacting and separating apparatus. The supersaturated air contained in the extracting solvent instantaneously leaches out in the heavy metal-polluted liquid waste to produce a large quantity of micro-sized and extracting solvent-bearing bubbles, which react with the heavy metal-polluted liquid waste in the pneumatic stirring, reacting and separating apparatus to quickly separate heavy metals from the liquid waste.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a system for separating and extracting heavy metals from polluted liquid waste according to a preferred embodiment of the present invention.

### DETAILED DESCRIPTION OF THE PREFERRED EMBODIMENTS

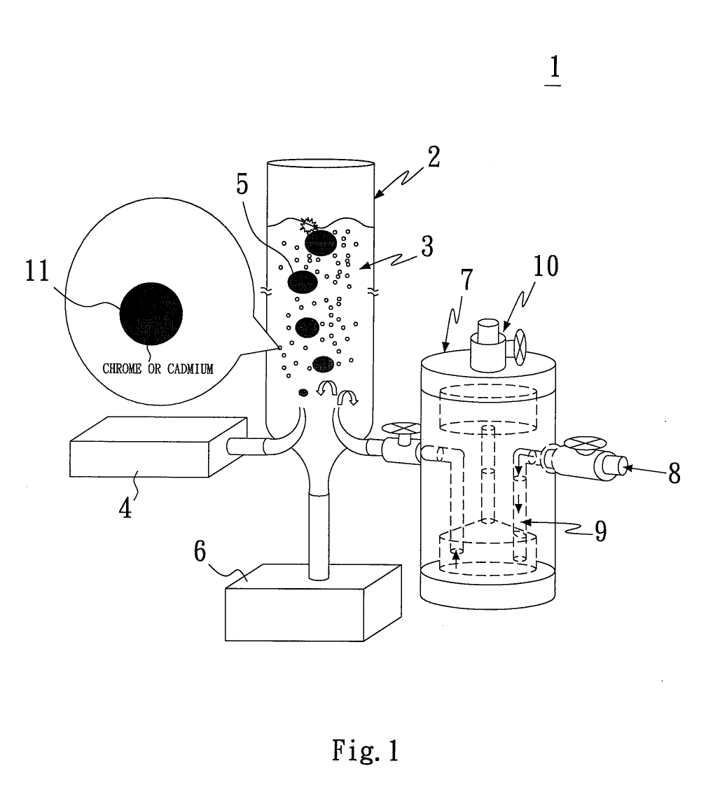

Please refer to FIG. 1 that shows a system for separating and extracting heavy metals from polluted liquid waste according to a preferred embodiment of the present invention. As shown, the system is generally denoted a reference numeral 1, and includes a pneumatic stirring, reacting and separating apparatus 2 for containing an amount of heavy metal-polluted liquid waste 3, including, but not limited to, cadmium-containing waste water or chrome-containing waste water; a gas supplying device 4 connected to a lower end of the pneumatic stirring, reacting and separating apparatus 2 for supplying an amount of gas 5, including but not limited to air, to stir the heavy metal-polluted liquid waste 3; a pumping unit 6 connected to a bottom of the pneumatic stirring, reacting and separating apparatus 2 for pumping out heavy metal-separated water that is obtained from a separation reaction occurred in the apparatus 2; and an extracting solvent pressurizing unit 7 connected to the lower end of the pneumatic stirring, reacting and separating apparatus 2, in which an amount of extracting solvent 9 is pressurized using a high-pressure gas 8, including but not limited to high-pressure air, so that the extracting solvent 9 is jetted to an axially central portion of the pneumatic stirring, reacting and separating apparatus 2 to react with the heave metal-polluted liquid waste 3.

The high-pressure gas has a pressure of from about 1 bar to about 5 bars. In the case the heavy metal to be removed is chrome, the extracting solvent 9 used should consist of a metal chelating agent, including but not limited to Aliquat 336, and organic diluent, including but not limited to kerosene at a ratio of from 5:1 to 1:10. And, in the case the heavy metal to be removed is cadmium, the extracting solvent 9 used should consist of a metal chelating agent, including but not limited to D2EHPA, and organic diluent, including but not limited to kerosene at a ratio of from 5:1 to 1:10. The kerosene is able to dissolve metal chelating agent to thereby produce a metal chelating agent-containing solvent that is immiscible with a water solution. Since the extracting solvent 9 has a specific gravity lower than that of water, and the pressurized extracting solvent 9 having been jetted into the pneumatic stirring, reacting and separating apparatus 2 would have a reduced pressure to thereby produce a large quantity of tiny oil-coated bubbles 11, which move upward while collecting and reacting with heavy metals in the polluted liquid waste 3.

The extracting solvent pressurizing unit 7 is provided at a predetermined position with a relief valve 10, allowing the pneumatic stirring, reacting and separating apparatus 2 to release extra pressure, and preventing the extracting solvent 9 from jetting out during pressure releasing.

In brief, the present invention provides a system for separating and extracting heavy metals from polluted liquid waste. The system 1 utilizes an extracting solvent pressurizing unit 7 to pressurize an amount of extracting solvent using a high-pressure gas, so that the extracting solvent contains supersaturated air. The extracting solvent containing supersaturated air is then jetted into a pneumatic stirring, reacting and separating apparatus. At this point, the supersaturated air contained in the extracting solvent instantaneously leaches out to thereby produce a large quantity of micro-sized extracting solvent-bearing bubbles, which react with the heavy metal-polluted liquid waste in the pneumatic stirring, reacting and separating apparatus to quickly separate the heavy metals from water to thereby achieve the object of removing heavy metals from polluted liquid waste.

What is claimed is:

1. A system for separating and extracting heavy metals from polluted liquid waste, comprising:
a pneumatic stirring, reacting and separating apparatus for containing an amount of heavy metal-polluted liquid waste therein;
a gas supplying device connected to the pneumatic stirring, reacting and separating apparatus for supplying an amount of gas to stir the heavy metal-polluted liquid waste in the pneumatic stirring, reacting and separating apparatus;
a pumping unit connected to the pneumatic stirring, reacting and separating apparatus for pumping out heavy metal-separated water obtained from the polluted liquid waste reacted in the pneumatic stirring, reacting and separating apparatus; and
an extracting solvent pressurizing unit, in which an amount of extracting solvent is pressurized using a high-pressure gas to thereby contain supersaturated air, and then jetted into the pneumatic stirring, reacting and separating apparatus; the supersaturated air contained in the extracting solvent instantaneously leaching out in the heavy metal-polluted liquid waste to thereby produce a large quantity of micro-sized and extracting solvent-bearing bubbles, which react with the heavy metal-polluted liquid waste in the pneumatic stirring, reacting and separating apparatus to quickly separate heavy metals from the liquid waste.

2. The system for separating and extracting heavy metals from polluted liquid waste as claimed in claim 1, wherein the polluted liquid waste is waste water containing chrome.

3. The system for separating and extracting heavy metals from polluted liquid waste as claimed in claim 1, wherein the polluted liquid waste is waste water containing cadmium.

4. The system for separating and extracting heavy metals from polluted liquid waste as claimed in claim 1, wherein the gas supplied from the gas supplying device is air.

5. The system for separating and extracting heavy metals from polluted liquid waste as claimed in claim 1, wherein the high-pressure gas for pressurizing the extracting solvent is high-pressure air.

6. The system for separating and extracting heavy metals from polluted liquid waste as claimed in claim 2, wherein the extracting solvent consists of a metal chelating agent and kerosene.

7. The system for separating and extracting heavy metals from polluted liquid waste as claimed in claim 3, wherein the extracting solvent consists of a metal chelating agent.

8. The system for separating and extracting heavy metals from polluted liquid waste as claimed in claim 6, wherein the metal chelating agent is Aliquat 336.

9. The system for separating and extracting heavy metals from polluted liquid waste as claimed in claim 7, wherein the metal chelating agent is D2EHPA.

10. The system for separating and extracting heavy metals from polluted liquid waste as claimed in claim 6, wherein a ratio of the metal chelating agent to the kerosene contained in the extracting solvent is within the range from 5:1 to 1:10.

11. The system for separating and extracting heavy metals from polluted liquid waste as claimed in claim 1, wherein the extracting solvent pressurizing unit is connected to a lower end of the pneumatic stirring, reacting and separating apparatus, and the pressurized extracting solvent is jetted to an axially central portion of the pneumatic stirring, reacting and separating apparatus.

12. The system for separating and extracting heavy metals from polluted liquid waste as claimed in claim 1, wherein the gas supplying device is connected to a lower end of the pneumatic stirring, reacting and separating apparatus.

13. The system for separating and extracting heavy metals from polluted liquid waste as claimed in claim 1, wherein the pumping unit is connected to a bottom of the pneumatic stirring, reacting and separating apparatus.

14. The system for separating and extracting heavy metals from polluted liquid waste as claimed in claim 1, wherein the extracting solvent pressurizing unit is provided at a predetermined position with a relief valve, allowing extra pressure inside the extracting solvent pressurizing unit to release via the relief valve and preventing the extracting solvent from jetting out during pressure releasing.

15. The system for separating and extracting heavy metals from polluted liquid waste as claimed in claim 1, wherein the high-pressure gas has a pressure within the range from 1 bar to 5 bars.
